(19) United States
(12) Patent Application Publication
(10) Pub. No.: US 2007/0040843 A1
(43) Pub. Date: Feb. 22, 2007

(54) SYSTEM FOR PROVIDING IMAGE CONTENTS AND DRAWING IMAGE, ELECTRONIC APPARATUS AND METHOD

(75) Inventor: Yasuhiro Tsuchida, Osaka (JP)

Correspondence Address: PEARNE & GORDON LLP, 1801 EAST 9TH SRTEET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/458,798

(22) Filed: Jul. 20, 2006

(30) Foreign Application Priority Data
Jul. 21, 2005 (JP) 2005-210902

(51) Int. Cl. G06T 9/00; G06F 17/30

(52) U.S. Cl. 345/555; 707/10

(57) ABSTRACT

A plurality of image files (Pa,Pb) are linked to obtain one linked image file 306 on the image contents server 300 side. Then, the linked image file is expanded only once, then only data of the necessary image file is cut out by looking up original image file group information (D1, 308), and then the data is displayed on a displaying portion 46 on the mobile terminal 100 side.

### BACKGROUND OF THE INVENTION

The present invention relates to a system for providing image contents and drawing an image, an image providing unit and an image drawing unit and, more particularly, the technology to realize a high-speed and highly convenient Java application runtime environment by reducing an image file acquiring time and a time required for processes such as bit map expansion, etc. to make no change in a drawing process using Java applications when an image is drawn by using the Java applications on a mobile terminal.

Improvements in multifunction and high performance of a mobile terminal (containing a PDA terminal, a light-weight small-sized portable computer, and the like in addition to a cellular phone terminal) are proceeding. According to this trend, the application using the object-oriented language such as Java (registered trademark), or the like can also be executed on the mobile terminal (JP-A-2003-228726, for example).

Java (registered trademark) is the object-oriented language has a salient feature of a multi-platform adaptability having a little model dependence, and possesses such advantages that this language is excellent in network adaptability and the user can obtain the integrated development environment without cost because the GUI (Graphical User Interface) forming tool is also equipped.

Here, the “object-oriented approach” means the approach that tries to execute the process by respective interactions (message exchanges) among a plurality of “objects” on the assumption that the object of process is handled as the independent “object” around the necessary data.

Also, the “Java application” means the program that is formulated by using Java (registered trademark) and is run solely on the computer.

For example, when an image file (illustration, icon, photo, 3D image, or the like) is downloaded by accessing the image contents server on the Internet while using the mobile terminal, into which the Java application is installed, and then displayed (drawn) on the display portion (screen) such as the LCD display, or the like, such image file must be accessed one by one and then downloaded every image file.

The downloaded image file is the data having a predetermined format (e.g., format that is compressed by the JPEG format, the GIF format, or the like). Therefore, according to the Java application installed in the mobile terminal, the image file is expanded into the data in a bit map format, then the image data expanded into the bit map is drawn on a VRAM (video RAM: random access memory for the purpose of image drawing), and then the image is displayed on the display portion (screen) based on the image data drawn on the VRAM.

However, in case a plurality of image files are downloaded individually, a communication must be established/disconnected every image file and also data attached to the data to be communicated actually (e.g., a header portion in the HTTP communication) must be transmitted/received every image file. As a result, a time required for the downloading is increased.

Also, when the downloaded image file is expanded into the bit map and when the Java application utilizes the image file formed in an expanded bit map format, a predetermined communication is needed between the Java application and the application used to expand the image file into the bit map, and thus a long time is consumed in executing this communication. As a result, if the downloading, the bit map expansion, and the utilization in the Java application are repeated individually to a plurality of image files as described above, much time is consumed until the image the user needs is displayed on the display portion.

### SUMMARY OF THE INVENTION

The present invention has been made based on such studies, and it is an object of the present invention to realize a high-speed and highly convenient Java application runtime environment by achieving a reduction in an image file acquiring time and a time required for processes such as bit map expansion, etc. not to make a change in a drawing process using Java applications when an image is drawn by using the Java applications on a mobile terminal, or the like.

A system of the present invention for providing image contents and drawing an image, includes an image file providing unit having a linked image file constructed by a plurality of image files that are linked mutually, and original image file group information containing respective position information of the plurality of image files on the linked image file; and an image drawing unit for receiving the linked image file and the original image file group information from the image file providing unit, expanding the linked image file into bit map data, cutting out an image file to be drawn from the linked image file that is expanded into the bit map data, based on the original image file group information, and drawing the bit map that is cut out.

In the present invention, the image file providing unit (the information recording medium inserted into the cellular phone terminal in use, for example, may be employed in addition to the image contents server on the communication network) links a plurality of image files together to get one linked image file and then provides this linked image file to the mobile terminal. Therefore, the downloading process and the data transferring process are needed only once in the mobile terminal, or the like on the side that receives the image file, and a time required for the downloading and the data transfer can be reduced. Also, since the image file expansion may be applied only once to the provided linked image file, a time required for the image expansion can be shortened. Also, it is the bit map data in which a plurality of image files are still linked that is obtained by expanding the linked image file into the bit map. In this case, since it is made clear by looking up the original image file group data where individual image files are now positioned in the bit map data, only the data of the necessary image file can be cut out from the bit map data based on the image file group data and can be displayed. Also, since the acquisition of the linked image file, the bit map expansion, and the cutting-out of individual image files can be concealed perfectly in the inside by implementing these processes, only the acquisition, the bit map expansion, and the display executed every image file in compliance with the conventional procedures are required of the user of these processes and therefore a time required for the processes can be reduced.

Also, in one mode of the system of the present invention for providing image contents and drawing an image, the image drawing unit includes a Java application, an image expanding unit for expanding the linked image file into bit map data, an image object generating unit for generating an image object containing image file position information, which indicates positions of respective image files in the linked image file in an expanded bit map format, based on the original image file group information in response to a request from the Java application, and an image storing unit for receiving a request for drawing the image object from the Java application, cutting out a bit map corresponding to the drawing request from the linked image file in the expanded bit map format by looking up the position information contained in the image object responding to the drawing request, and storing the bit map in an image displaying memory.

The Java application processes the image file as the object of drawing or the bit map data expanded from the image file as the image object. In this case, the bit map data of respective image files are linked together to form one data, and the image object cannot be generated every image file by using the linked data as it is. For this reason, in the present invention, the image object is generated mainly based on the information used to cut out the bit map data of the target image file from the bit map data of the linked image file (the position information of the target image file in the linked image file, the color palette information, or the like) and the information used to access the bit map data (the reference, the pointer, or the like) instead of the bit map data of the image file. By doing this, the Java application can utilize respective image files as the image object in the conventional manner and, upon drawing the image, the image drawing unit cuts out the bit map data of a desired image file from the linked image file that has been expanded into the bit map, by looking up the above information contained in the image object and then displays the data on the displaying portion (screen). In this manner, in the present invention, the side that utilizes the image object can speed up a series of processes to pay no regard to a change in the internal process.

Also, a contents distributing server of the present invention is a contents distributing server provided on a communication network as the image providing unit in the system of the present invention.

This contents distributing server is the contents distributing server having a function of generating one linked image file by linking a plurality of image files together, and also generating original image file group information as auxiliary information used to cut off each image file.

Also, an information recording medium on which image contents of the present invention are recorded is an information recording medium, on which image contents are recorded, serving as the image providing unit in the system of the present invention.

This information recording medium is the information recording medium (various memory cards, and the like) on which the linked image file constructed by a plurality of image files being linked mutually and the original image file group information as the auxiliary information used to cut off each image file are recorded.

Also, the electronic apparatus of the present invention includes an image drawing unit in the system of the present invention, and a displaying portion for displaying the image being sent from the image drawing unit.

The electronic apparatus of the present invention is the electronic apparatus that has a function of expanding the linked image file into the bit map and a function of cutting out bit map data of the necessary image file based on the original image file group information and then displaying the data. A mobile terminal having a function of expanding the linked image file into the bit map and a function of cutting out the bit map data of the necessary image file based on the original image file group information and then displaying the data (containing a PDA terminal and a light-weight small-sized portable computer in addition to a cellular phone terminal) is also contained in the electronic apparatus of the present invention.

Also, a method of the present invention of providing image contents and drawing an image, includes forming a linked image file by linking a plurality of image files mutually; providing the linked image file and original image file group information containing respective position information of the plurality of image files on the linked image file to a device that draws an image; receiving the linked image file and the original image file group information by the device that draws the image; expanding the linked image file into bit map data; cutting out an image file to be drawn from the linked image file that is expanded into the bit map data, based on the original image file group information; and drawing the bit map that is cut out.

According to this method, a plurality of image files can be linked together to get a single image file. Therefore, the number of times the image files should be read and expanded into the bit map can be reduced, and also a desired image file can be cut out individually based on the original image file group information.

According to the present invention, a plurality of image files are linked to get one linked image file and then this linked image file is provided to the mobile terminal. Therefore, the downloading process and the data transferring process are needed only once in the mobile terminal, or the like on the side that receives the image file, a time required for the downloading and the data transfer can be reduced.

Also, since the image file expansion may be applied only once to the provided linked image file, the image expanding process can be sped up.

Also, it is the bit map data in which a plurality of image files are still linked that is obtained by expanding the linked image file into the bit map. In this case, it is made clear by looking up the original image file group data where individual image files are now positioned in the bit map data. Therefore, only the data of the necessary image files can be cut out from the bit map data based on the image file group data, and can be displayed.

Also, the processes concerning the acquisition of the linked image file, the bit map expansion, and the cutting-out of individual image files can be concealed as internal processes. Therefore, only the acquiring/expanding/drawing processes of the image file executed in compliance with the conventional procedures are required of the user.

Also, when the image is displayed on the screen by using the Java application, the image object is generated mainly based on the information used to cut out the bit map data (the position information indicating the position of the target image file in the linked image file, the color palette information, or the like) instead of the bit map data of the image file. Therefore, the Java application can issue the drawing request merely in unit of the image object like the prior art, and thus the program never becomes complicated because of the introduction of the present approach.

In this manner, in the present invention, there is no need that the Java application should be conscious of a change in the internal process.

As a result, when the image is drawn by using the Java applications on the mobile terminal in particular, a high-speed and highly convenient Java application runtime environment can be realized by achieving a reduction in the image file acquiring time and the time required for processes such as bit map expansion, etc. not to make a change in the drawing process in terms of the Java applications.

### BRIEF DESCRIPTION OF THE DRAWINGS

The object and advantages of the present invention will be made clear by means of the description in the detailed description of the preferred embodiment with reference to the accompanying drawings.

FIG. 1 is a block diagram showing a configuration of a system of the present invention (containing an image providing unit and an image drawing unit) that provides image contents and draws an image;

FIG. 2 is a view explaining a process of linking a plurality of image files in an image contents server in FIG. 1;

FIG. 3 is a view explaining a concrete example where respective image files are linked together;

FIG. 4 is a view showing a mode in which a linked image file and original image file group information are saved in a file holding unit;

FIG. 5 is a view explaining more concrete contents of the process of the linked image file and original image file group information in the mobile terminal; and

FIG. 6A and FIG. 6B are views explaining the reason why the image drawing in the mobile terminal can be sped up by the present invention, wherein FIG. 6A is a view showing procedures in a method of downloading individually the files and then expanding them into a bit map in the prior art, and FIG. 6B is a view showing procedures in a method of the present invention (method of downloading simultaneously linked image files and then expanding them into a bit map).

### DETAILED DESCRIPTION OF THE PREFERRED EMBODIMENTS

An embodiment of the present invention will be explained with reference to the drawings hereinafter.

### First Embodiment

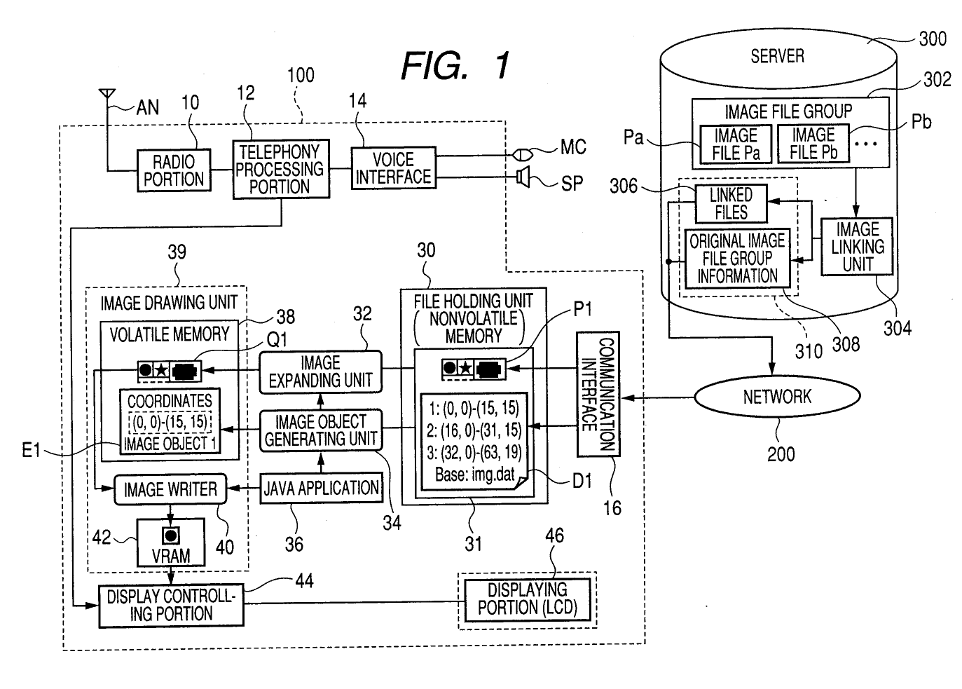

FIG. 1 is a block diagram showing a configuration of a system of the present invention (containing an image providing unit and an image drawing unit) that provides image contents and draws an image.

As shown on the right side in FIG. 1, an image contents server 300 includes an image file storing nonvolatile memory 302 (containing a plurality of image files Pa, Pb, . . . ), an image linking unit 304 (having functions of generating a linked image file 306 and original image file group information 308), and a nonvolatile memory 310 for holding the linked image file 306 and the original image file group information 308.

This image contents server 300 is located on a communication network 200.

Also, as shown on the left side in FIG. 1, a mobile terminal (a cellular phone terminal) 100 includes an antenna AN, a radio portion 10, a telephony processing portion 12, a voice interface 14, a communication interface 16 connected to the communication network 200, a microphone MC and a speaker SP, a file holding unit 30 (for holding a linked image file unit P1 (identical to a reference numeral 306) and an original image file group information D1 (identical to a reference numeral 308)), an image expanding unit 32 for expanding the linked image file unit P1 in the JPEG format, the GIF format, or the like into the bit map data, an image object generating unit 34, a Java application 36, an image drawing unit 39, a display controlling portion 44, and a displaying portion (Liquid Crystal Display) 46.

Here, the image drawing unit 39 has a volatile memory 38 such as a DRAM, or the like, which holds temporarily a linked image file Q1 expanded into the bit map and an image object E1 generated by the image object generating unit 34, an image writer 40, and a VRAM (video RAM) 42 as an image drawing memory.

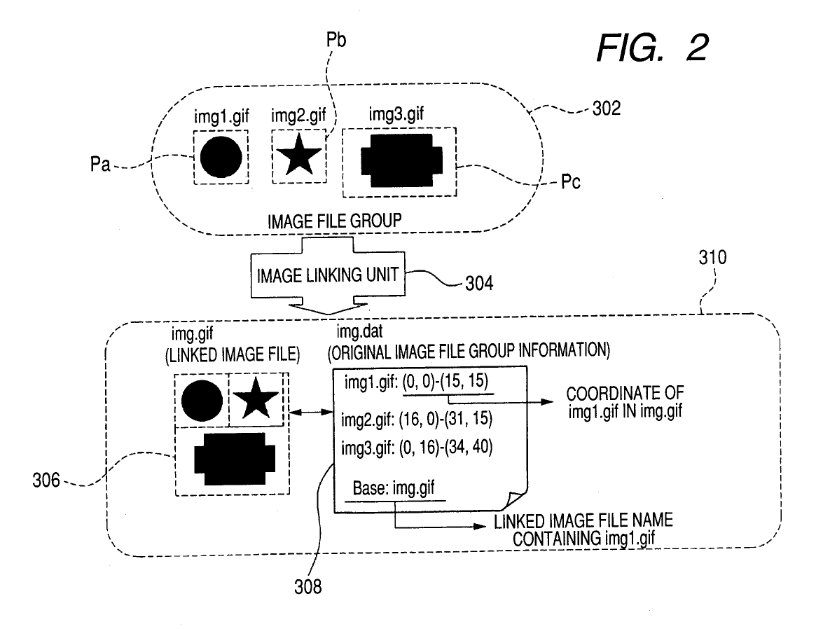

FIG. 2 is a view explaining a process of linking a plurality of image files in the image contents server (reference numeral 300) in FIG. 1. In FIG. 2, common reference symbols are affixed to the same portions as those in FIG. 1 (this respect is true of following drawings).

As shown in FIG. 2, three image files (Pa to Pc) in the GIF format are stored in the image file storing nonvolatile memory 302.

The image linking unit 304 takes out respective image files (Pa to Pc) from the image file storing nonvolatile memory 302, and then links respective image files together under predetermined linking rules.

As the respective image files, for example, the matrix linking system by which the images are linked two-dimensionally sequentially from the first from the file having a small size, the simple linking system by which the images are arranged at first one-dimensionally, then the row is shifted when the images reach a predetermined amount of data, and then the images are arranged similarly one-dimensionally, and the like are considered.

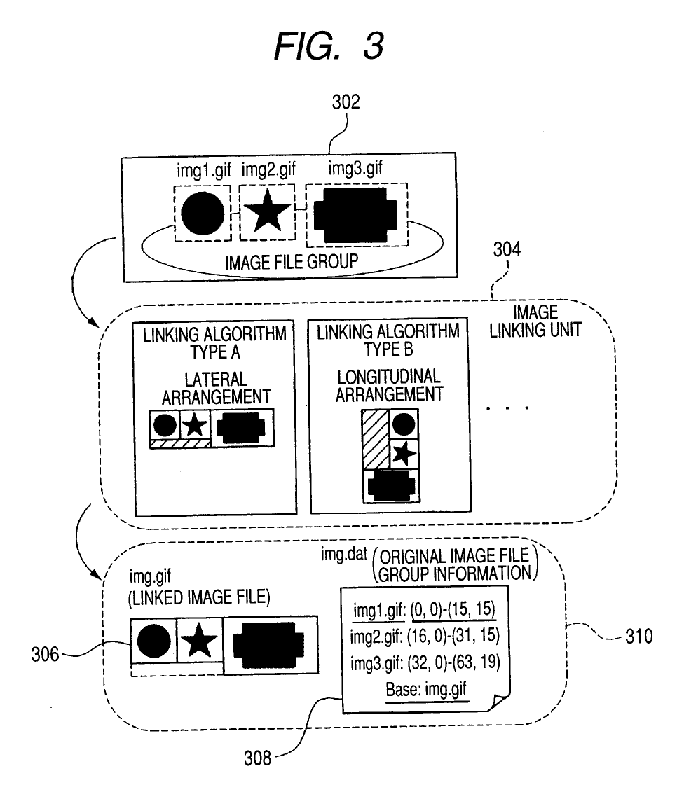

FIG. 3 is a view explaining a concrete example where respective image files are linked together.

As shown in the center of FIG. 3, a linking algorithm (type A) has the lateral arrangement system, and a linking algorithm (type B) has the longitudinal arrangement system.

In this manner, the linked image file 306 is formed. At this time, the original image file group information 308 is also formed simultaneously. The original image file group information 308 contains the coordinate (position) information indicating where respective image files (Pa to Pc) should be positioned in the linked image file 306 (see FIG. 2 and FIG. 3). The linked image file 306 corresponds to the original image file group information 308, and both are never separated and are associated with each other.

The linked image file 306 and the original image file group information 308, which have been formed, are stored in the nonvolatile memory 310 (see FIG. 1).

Then, the request for the downloading of the image file is issued from the mobile terminal 100, the image contents server 300 transmits the linked image file 306 and the original image file group information 308 to the mobile terminal 100.

The mobile terminal 100 receives the linked image file 306 and the original image file group information 308 via the communication interface 16.

The received files and information are stored in the file holding unit 30 (the nonvolatile memory such as EPROM, or the like) of the mobile terminal 100 as the linked image file P1 and the original image file group information D1.

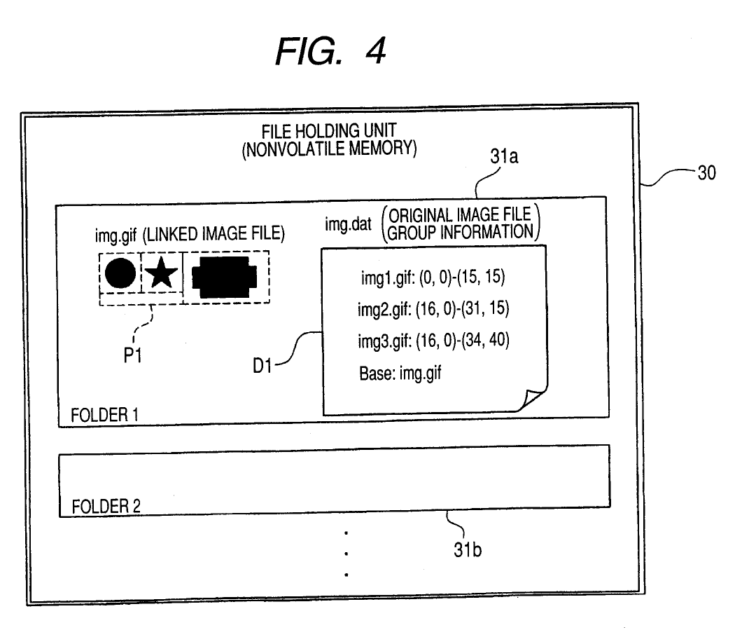

FIG. 4 is a view showing a mode in which the linked image file (reference symbol P1) and the original image file group information (reference symbol D1) are saved in the file holding unit (reference numeral 30).

As shown in FIG. 4, the linked image file P1 and the original image file group information D1 are saved in the file holding unit 30 (the nonvolatile memory such as EPROM, or the like) every folder (in the case of FIG. 4, they are save in a folder 1).

Then, returning to FIG. 1, (an outline of) the processes applied to the linked image file P1 and the original image file group information D1 will be explained hereunder.

After the Java application 36 is started, the image expanding unit 32 expands (converts) the linked image file P1 in the GIF format into the linked image file Q1 in the bit map format at a timing at which any image file contained in the linked image files is utilized.

Also, the image object generating unit 34 extracts position information (coordinate information) of the image file to be drawn in the original image file group information D1 (in addition, when the original image file group information D1 contains color palette information (information indicating which colors should be allocated to respective tones), this information may be added to the position information). Then, this image object generating unit 34 generates the image object E1 to contain these information and information used to access the expanded bit map data Q1 (reference, pointer, URI, and the like).

The linked image file Q1 in the bit map format and the image object E1 are stored in the volatile memory 38 such as DRAM, or the like in the image drawing unit 39.

The Java application 36 instructs the image writer 40 to draw the image object E1. Then, the image writer 40 cuts out the image file to be drawn from the linked image file Q1 in the bit map format based in the position information (coordinate information) in the image object E1, etc. and then writes the cut bit map data into the VRAM 42.

The display controlling unit 44 displays the bit map on the displaying portion (Liquid Crystal Display) 46 based on the bit map data written into the VRAM 42.

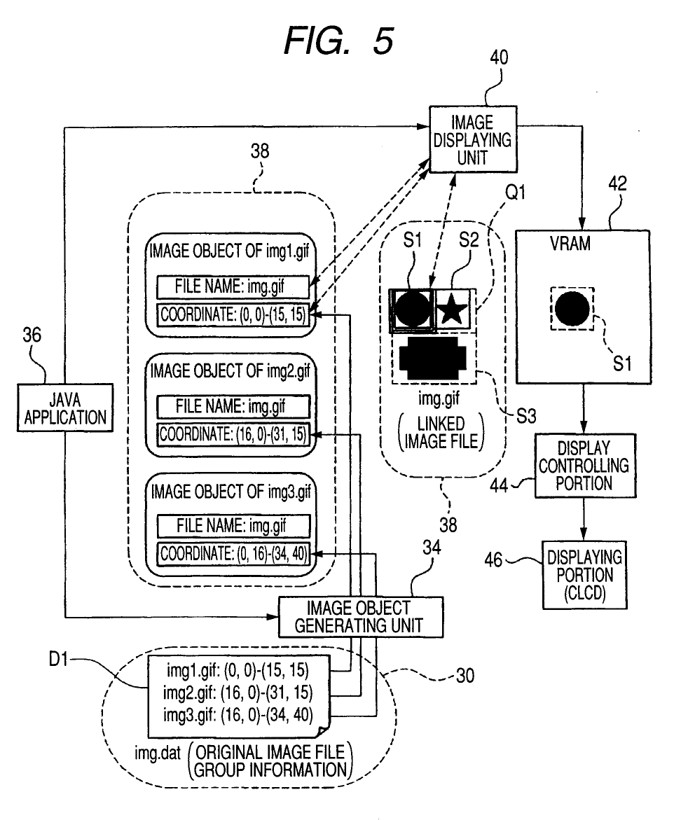

FIG. 5 is a view explaining more concrete contents of the process of the linked image file (reference symbol Q1) and original image file group information (reference symbol E1) in the mobile terminal.

In FIG. 5, the Java application 36 instructs the image object generating unit 34 to generate the image objects (E1, and the like). More particularly, the image object generating unit 34 searches the original image file group information (img.dat) in the file holding unit 30, and then acquires the file name (img.gif) of the linked image file from the searched original image file group information (img.dat).

Then, the image object generating unit 34 requests the image expanding unit 32 to expand the linked image file (img.gif) in which the image file (img1.gif).

Then, the image expanding unit 32 expands the linked image file (img.gif) into the bit map format, and writes the bit map into the volatile memory 38.

Then, the image object generating unit 34 generates the image object (image object 1) to point the bit map data (img1.gif) of the expanded image on the volatile memory 38, based on the original image file group information and address information of the expanded image file on the volatile memory 38.

Then, the Java application 36 requests the image writer 40 to draw the image object 1.

The image writer 40 cuts out only the bit map data concerning the image file 1 (img1.gif) in the expanded bit map data on the volatile memory by utilizing the coordinate information that the image object 1 holds, and transfers the data to the VRAM 42.

Then, under control of the display controlling portion 44, the image of the image file 1 is displayed on the displaying portion 46.

In this manner, when the image is displayed on the screen by using the Java application, the image object is formed by using the position information indicating the cut-out position of the bit map data (position in the linked image file) (color palette information, etc. may be contained in this position information) instead of the bit map data of the image file. Therefore, the Java application can carry out the drawing process by the image object, and as a result the program never becomes complicated due to the introduction of the present approach.

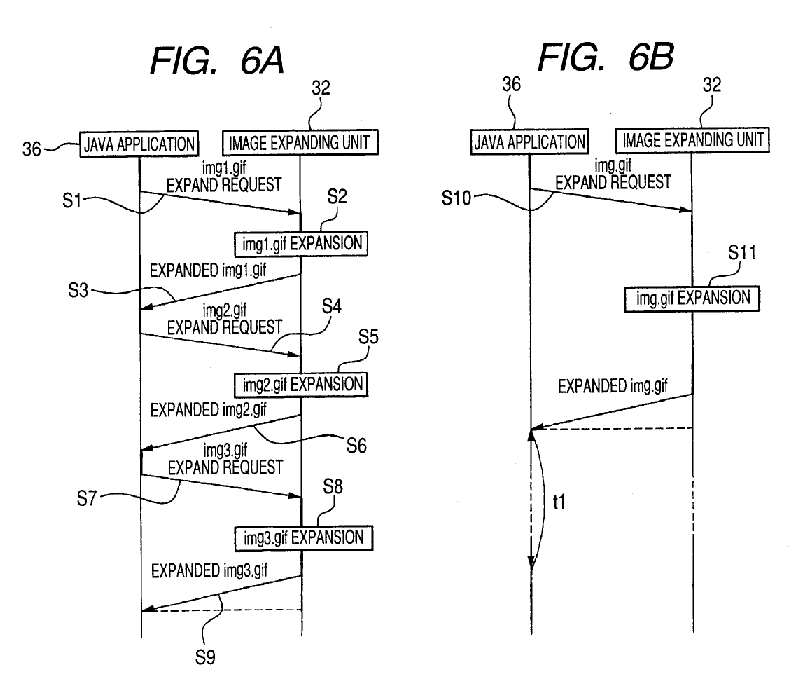

FIG. 6A and FIG. 6B are views explaining the reason why the image drawing in the mobile terminal can be sped up by the present invention. Here, FIG. 6A is a view showing procedures in a method of downloading individually the files and then expanding them into a bit map in the prior art, and FIG. 6B is a view showing procedures in a method of downloading simultaneously linked image files and then expanding them into a bit map of the present invention.

In FIG. 6A, S1, S4, S7 denote the process applied to issue the request to the effect that each image file should be expanded individually into the bit map respectively, S2, S5, S8 denote the individual bit map expanding process of each image file respectively, and S3, S6, S9 denote the transferring process of each image file that is expanded into the bit map respectively.

In FIG. 6B, S10 denotes the process applied to issue the request to the effect that the linked image file should be expanded collectively into the bit map, S11 denotes the bit map expanding process of the linked image file, and S3, S6, S9 denote the transferring process of the expanded image file respectively.

As apparent from the comparison between FIG. 6A and FIG. 6B, the process can be ended earlier by t1 by employing the processing method of the present invention.

More particularly, when the downloaded image file is expanded into the bit map and when the Java application utilizes the image file in the expanded bit map format, the predetermined communication is needed between the Java application and the application used to expand the image file into the bit map, and thus a long time is consumed in executing this communication. Therefore, as shown in FIG. 6A, if the downloading, the bit map expansion, and the transfer to the Java application are repeated individually to a plurality of image files, much time is consumed until the image the user needs is displayed on the display portion.

In contrast, as shown in FIG. 6B, if the linked image file is expanded collectively into the bit map and then the bit map data are expanded collectively in the Java application, the process is required only once. Therefore, a processing time can be reduced considerably.

With the above, the present invention is explained based on the embodiment. But the present invention is not limited to this embodiment, and various variations can be applied. For example, in the above embodiment, the image contents are provided from the server provided on the communication network. But the image contents may be provided from the information recording medium (various IC cards, or the like) that is connectable to the mobile terminal.

As explained above, according to the present invention, a plurality of image files are linked to get one linked image file and then this linked image file is provided to the mobile terminal. Therefore, the downloading process and the data transferring process are needed only once in the mobile terminal, or the like on the side that receives the image file, a time required for the downloading and the data transfer can be reduced, and the user's operation of the device such as the mobile terminal, or the like can be simplified.

Also, since the image file expansion may be applied only once to the provided linked image file, the image expanding process can be sped up.

Also, it is the bit map data in which a plurality of image files are still linked that is obtained by expanding the linked image file into the bit map. In this case, it is made clear by looking up the original image file group data where individual image files are now positioned in the bit map data. Therefore, only the data of the necessary image files can be cut out from the bit map data based on the image file group data, and can be displayed.

Also, the acquisition of the linked image file, the bit map expansion, and the cutting-out of individual image files can be concealed perfectly in the inside by implementing these processes. Therefore, only the acquiring/expanding/drawing processes executed every image file in compliance with the conventional procedures are required of the user of these processes.

Also, when the image is displayed on the screen by using the Java application, the image object is generated mainly based on the position information indicating the cut-out position (position in the linked image file) of the bit map data (the color palette information, or the like may be contained) in place of the bit map data of the image file. Therefore, since the Java application can carry out the drawing process by using the image object in accordance with the procedures like the prior art, the program never becomes complicated because of the introduction of the present approach.

In this manner, in the present invention, there is no need that the Java application should be aware of a change in the internal process.

As a result, when the image is drawn by using the Java applications on the mobile terminal in particular, the technology to realize the high-speed and highly convenient Java application runtime environment by achieving a reduction in the image file acquiring time and the time required for processes such as bit map expansion, etc. not to make a change in the drawing process in terms of the Java applications can be provided.

The present invention possesses such an advantage that the technology to realize the high-speed and highly convenient Java application runtime environment by reducing an image file acquiring time and a time required for processes such as bit map expansion, etc. to make no change in a drawing process using Java applications when an image is drawn by using the Java applications on a mobile terminal can be provided, and therefore is useful to the system that provides the image contents and draws the image, the image providing unit, the image drawing unit, various electronic apparatuss for displaying the image, the mobile terminal (containing a PDA terminal, a light-weight small-sized portable computer, and the like in addition to a cellular phone terminal).

What is claimed is:

1. A system for providing image contents and drawing an image, comprising:
an image file providing unit that stores a linked image file constructed by a plurality of image files which are linked to each other, and original image file group information containing respective position information of the plurality of image files on the linked image file; and
an image drawing unit that receives the linked image file and the original image file group information from the image file providing unit, expands the linked image file into bit map data, cuts out an image file to be drawn from the linked image file which is expanded into the bit map data based on the original image file group information, and draws the bit map which is cut out.

2. The system according to claim 1, wherein the image drawing unit includes:
a Java application;
an image expanding unit which expands the linked image file into the bit map data;
an image object generating unit which generates an image object containing image file position information, which indicates positions of respective image files in the linked image file in an expanded bit map format, based on the original image file group information in response to a request from the Java application; and
an image storing unit which receives a request for drawing the image object from the Java application, cuts out a bit map corresponding to the drawing request from the linked image file in the expanded bit map format by looking up the position information contained in the image object responding to the drawing request, and stores the bit map in an image displaying memory.

3. An electronic apparatus, comprising:
an image drawing unit that receives a linked image file constructed by a plurality of image files which are linked to each other and original image file group information containing respective position information of the plurality of image files on the linked image file, expands the linked image file into bit map data, cuts out an image file to be drawn from the linked image file which is expanded into the bit map data based on the original image file group information, and draws the bit map which is cut out; and
a displaying portion that displays an image transferred from the image drawing unit.

4. The electronic apparatus according to claim 3, wherein the image drawing unit includes;
a Java application;
an image expanding unit which expands the linked image file into bit map data;
an image object generating unit which generates an image object containing image file position information, which indicates positions of respective image files in the linked image file in an expanded bit map format, based on the original image file group information in response to a request from the Java application, and
an image storing unit which receives a request for drawing the image object from the Java application, cuts out a bit map corresponding to the drawing request from the linked image file in the expanded bit map format by looking up the position information contained in the image object responding to the drawing request, and stores the bit map in an image displaying memory.

5. A method of providing image contents and drawing an image, comprising:
forming a linked image file by linking a plurality of image files to each other;
providing the linked image file and original image file group information containing respective position information of the plurality of image files on the linked image file to a device which draws an image;
receiving the linked image file and the original image file group information by the device which draws the image;
expanding the linked image file into bit map data;
cutting out an image file to be drawn from the linked image file which is expanded into the bit map data, based on the original image file group information; and
drawing the bit map which is cut out.
